(19) United States
(12) Patent Application Publication
(10) Pub. No.: US 2026/0235936 A1
(43) Pub. Date: Aug. 13, 2026

(54) EXPOSED CAMERA ARCHITECTURES

(71) Applicant: Meta Platforms Technologies, LLC, Menlo Park, CA (US)

(72) Inventors: Lidu Huang, Danville, CA (US); Peng Chen, Fremont, CA (US); Likai Li, Cupertino, CA (US)

(21) Appl. No.: 19/530,747

(22) Filed: Feb. 5, 2026

Related U.S. Application Data
(60) Provisional application No. 63/757,718, filed on Feb. 12, 2025.

(51) Int. Cl. G03B 17/12; G03B 13/36; G03B 30/00; H04N 23/55; H04N 23/57; H04N 23/68

(52) U.S. Cl. CPC G03B 17/12; G03B 13/36; G03B 30/00; H04N 23/55; H04N 23/57; H04N 23/687; H04N 23/6812

(57) ABSTRACT

A camera module includes a lens assembly and an image sensor. The lens assembly is configured to focus image light to the image sensor. A protective sleeve is disposed around at least a portion of the lens assembly.

### CROSS-REFERENCE TO RELATED APPLICATIONS

This application claims priority to U.S. provisional Application No. 63/757,718 filed Feb. 12, 2025, which is hereby incorporated by reference.

### TECHNICAL FIELD

This disclosure relates generally to optics, and in particular to cameras.

### BACKGROUND INFORMATION

Cameras on consumer devices are vulnerable to environmental hazards that can compromise their performance and longevity. Drops can cause lens misalignment or damage to internal mechanics, for example. Additionally, exposure to contaminants like dust, sand, or liquids can infiltrate the housing of the camera and cause damage to the optics or electronics. Incorporating cameras into wearable devices may heighten the priority for protection against external hazards.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a head-mounted device that includes one or more cameras, in accordance with aspects of the disclosure.

FIG. 2A includes a camera module having an image sensor, a lens assembly, and a protective sleeve, in accordance with aspects of the disclosure.

FIG. 2B illustrates a perspective view of an example protective sleeve, in accordance with aspects of the disclosure.

FIG. 3 illustrates a camera module including a silicone protective sleeve, in accordance with aspects of the disclosure.

FIG. 4 illustrates a camera module having a protective sleeve and an adjustable lens module including one or more refractive lens elements adjustable along an optical axis of the camera module, in accordance with aspects of the disclosure.

FIG. 5 illustrates a camera module for using without coverglass that includes a protective sleeve, in accordance with aspects of the disclosure.

FIG. 6 illustrates a camera module for using without coverglass that includes optical image stabilization (OIS), autofocus (AF), and a protective sleeve, in accordance with aspects of the disclosure.

### DETAILED DESCRIPTION

Embodiments of exposed camera architectures are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Currently, cameras in electronic devices and instruments are protected with a cover window also known as coverglass. Autofocus and optical image stabilization enabled cameras that are exposed to the environment are not currently manufactured due to severe drop failures. In other words, cameras rely on the cover window to survive the mechanical stress from drops.

In the development of wearable electronics, such as smart glasses, AR, VR, and Artificial Intelligence (AI) assisted devices, there is a growing desire to shrink the camera and reduce camera appearance. One approach to achieve this is by removing the protective cover window. However, without this protective layer, the camera module becomes more vulnerable to environmental factors like dust, moisture, scratches, and the drop failures. Conventional autofocus (AF) and optical image stabilization (OIS) cameras that utilize lens shift technology are not suitable for exposure due to gaps around the lens, which can allow particles to enter the light path.

Exposed or exposable cameras (camera modules without coverglass or cover windows) are disclosed in implementations of the disclosure. In some implementations, the exposed/exposable cameras include autofocus (AF). Exposable autofocus camera may include: (1) the exposed lens portion fixed relative to the camera module mechanical control outline (MCO) so the camera is protected from scratch, moisture ingression, corrosion, and mechanical impact; (2) Exposable AF and OIS camera having fixed MCO and shock absorption mechanism; (3) a surface deformable autofocus lens embedded in the lens with shock absorption; (4) a shiftable auto-focus lens group (single or multiple lens elements) embedded in the lens with shock absorption; (5) sensor shift optical image stabilization with shock absorption; and/or (6) Sensor shift optical image stabilization and embedded AF with shock absorption.

By removing the traditional cover window in camera modules, designers can create a more streamlined and visually appealing product. Additionally, removing the cover window reduces visual obstruction. Exposed cameras having reduced visual obstruction expand the field of view (FOV) of the camera and may allow users to enjoy an unobstructed view of their surroundings. This may be particularly important for applications like augmented reality (AR) and virtual reality (VR), where a clear field of view is important. Yet another advantage of removing the cover window and utilizing exposed cameras is increased design flexibility-exposed cameras offer designers greater flexibility when it comes to creating innovative and unique product designs. Without the constraints of a traditional camera housing, designers can experiment with new shapes, materials, and form factors.

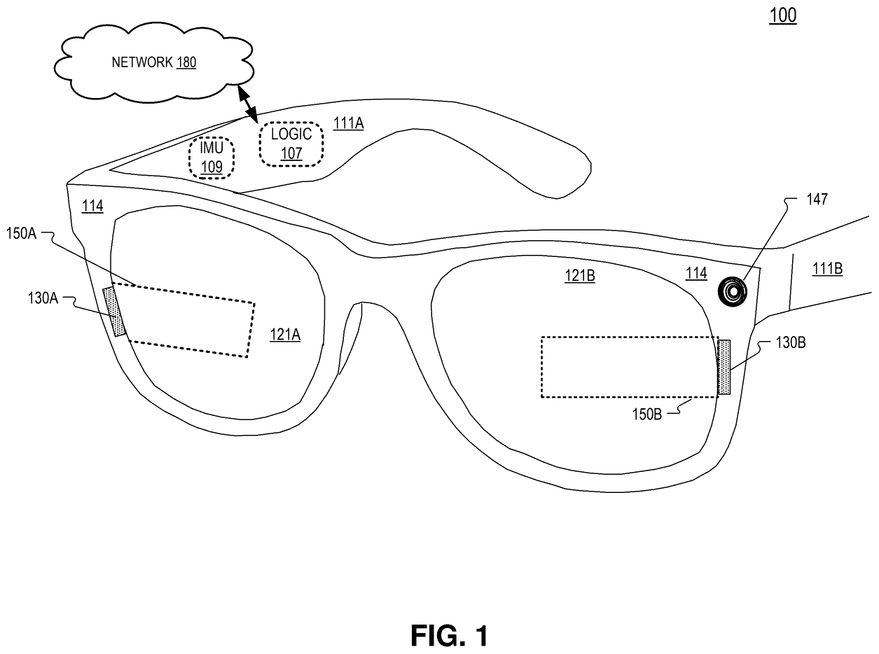

FIG. 1 illustrates a head-mounted device 100 that includes one or more cameras 147 that may be exposed to an external environment, in accordance with aspects of the present disclosure. Camera(s) 147 may include a protective sleeve. Camera 147 may be exposed to an external environment of the head-mounted device 100. Head-mounted device 100 includes frame 114 coupled to arms 111A and 111B. Lens assemblies 121A and 121B are mounted to frame 114. Lens assemblies 121A and 121B may include prescription lenses matched to a particular user of head-mounted device 100. The illustrated head-mounted device 100 is configured to be worn on or about a head of a wearer of head-mounted device 100.

In the head-mounted device 100 illustrated in FIG. 1, each lens assembly 121A/121B includes a waveguide 150A/150B to direct image light generated by displays 130A/130B to an eyebox area for viewing by a user of head-mounted device 100. Displays 130A/130B may include a beam-scanning display or a liquid crystal on silicon (LCOS) display for directing image light to a wearer of head-mounted device 100 to present virtual images, for example. Hence, head-mounted device 100 may be considered a head-mounted display (HMD) when a near-eye display is included in head-mounted device 100.

Lens assemblies 121A and 121B may appear transparent to a user to facilitate augmented reality or mixed reality to enable a user to view scene light from the environment around them while also receiving image light directed to their eye(s) by, for example, waveguides 150. Lens assemblies 121A and 121B may include two or more optical layers for different functionalities such as display, eye-tracking, and optical power. In some embodiments, image light from display 130A or 130B is only directed into one eye of the wearer of head-mounted device 100. In an embodiment, both displays 130A and 130B are used to direct image light into waveguides 150A and 150B, respectively. The implementations of the disclosure may also be used in head-mounted devices (e.g. smartglasses) that don't necessarily include a display but are configured to be worn on or about a head of a wearer.

Frame 114 and arms 111 may include supporting hardware of head-mounted device 100 such as processing logic 107, a wired and/or wireless data interface for sending and receiving data, graphic processors, and one or more memories for storing data and computer-executable instructions. Processing logic 107 may include circuitry, logic, instructions stored in a machine-readable storage medium, ASIC circuitry, FPGA circuitry, and/or one or more processors. In one embodiment, head-mounted device 100 may be configured to receive wired power. In one embodiment, head-mounted device 100 is configured to be powered by one or more batteries. In one embodiment, head-mounted device 100 may be configured to receive wired data including video data via a wired communication channel. In one embodiment, head-mounted device 100 is configured to receive wireless data including video data via a wireless communication channel. Processing logic 107 may be communicatively coupled to a network 180 to provide data to network 180 and/or access data within network 180. The communication channel between processing logic 107 and network 180 may be wired or wireless.

In FIG. 1, head-mounted device 100 includes an inertial measurement unit (IMU) 109 configured to generate motion signals. IMU 109 may be communicatively coupled to processing logic 107. Processing logic 107 may be configured to receive motion signals from IMU 109. IMU 109 may include gyroscopes to measure angular velocity, accelerometers to detect linear acceleration, and/or magnetometers to sense the magnetic field of the earth. All or a portion of the signals may be included in the motion data generated by IMU 109. IMU 109 may provide motion data to calculate position and attitude (orientation) of the head-mounted device 100 over time.

In the illustrated implementation of FIG. 1, head-mounted device 100 includes a camera 147. Camera 147 is illustrated as a front-facing camera in FIG. 1, although cameras described in the disclosure may be oriented to capture images from alternative perspectives. Head-mounted device 100 may include more than one camera that include the camera protection features described herein.

Camera 147 may include a lens assembly configured to focus image light to a complementary metal-oxide semiconductor (CMOS) image sensor, in some implementations. A near-infrared filter that receives a narrow-band near-infrared wavelength may be placed over the image sensor so it is sensitive to the narrow-band near-infrared wavelength while rejecting visible light and wavelengths outside the narrow-band.

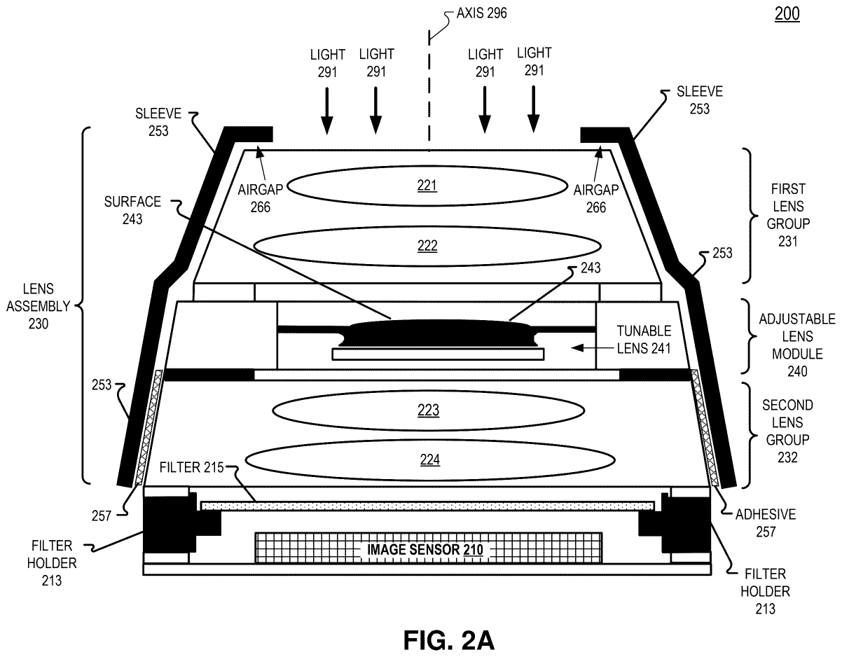

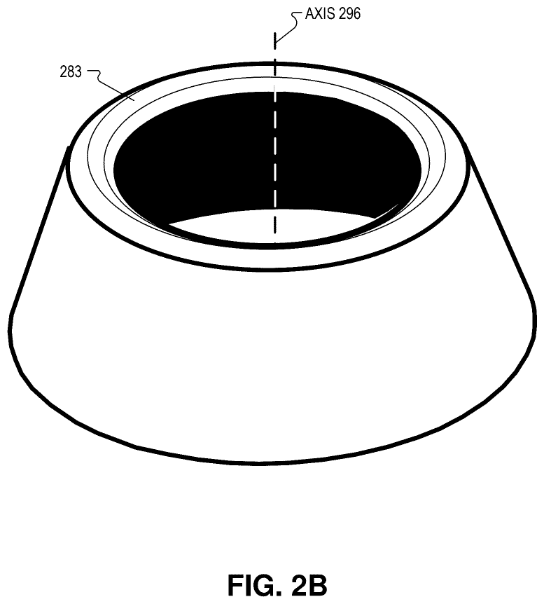

FIG. 2A includes a camera module 200 including an image sensor 210, a lens assembly 230, and a protective sleeve 253, in accordance with aspects of the disclosure. The lens assembly 230 focuses image light 291 onto the image sensor 210. Image sensor 210 may include a CMOS image sensor. Lens assembly 230 includes a first lens group 231, an adjustable lens module 240, and a second lens group 232. The first lens group 231 includes a first lens element 221 to be exposed to an external environment. The second lens group 232 shares an optical axis 296 with the first lens group 231 and the adjustable lens module 240.

Camera module 200 may include a filter holder 213 configured to provide support for a filter 215 configured to filter image light 291 prior to image light 291 becoming incident on image sensor 210. In some implementations, filter 215 is an infrared filter that blocks infrared light from becoming incident on image sensor 210 while transmitting visible light to image sensor 210.

First lens group 231 may include first lens element 221 to be exposed to an external environment of a device. The first lens group 231 may include a plurality of refractive lens elements such as elements 221 and 222. The first lens element 221 (top lens element) may be glass (instead of plastic) to reduce any scratches from the first lens element 221 being exposed to the external environment. The glass of the first element may include a hard coating to avoid scratches and fingerprints, in some implementations. All or a portion of the entire first lens group 231 may be exposed to the external environment, in some aspects.

Second lens group 232 is disposed between the image sensor 210 and the adjustable lens module 240. The second lens group 232 may include a plurality of refractive lens elements such as elements 223 and 224. The lens elements in second lens group 232 may be plastic.

In FIG. 2A, adjustable lens module 240 includes a tunable lens 241 having a deformable surface 243 for adjusting focus of the image light 291 to the image sensor 210. Camera module 200 further includes a protective sleeve 253 disposed around the lens assembly 230. The protective sleeve 253 is adhered to the second lens group 232 and not adhered to the first lens group 231 nor the tunable lens (included in lens module 240) so that any mechanical shock received by the protective sleeve 253 is transferred to the second lens group 232 and not the first lens group 231 and not the tunable lens 241.

In some implementations, the protective sleeve 253 is disposed around the first lens group 231, the second lens group 232, and the adjustable lens module 240. In some implementations, protective sleeve 253 is metal.

Protective sleeve 253 may be adhered to the second lens group 232 by an adhesive 257. In an implementation, adhesive 257 is a soft adhesive having a Young's modulus between 1 kPa and 100 MPa. In some implementations, adhesive 257 has a Young's modulus between 10 MPa and 100 MPa. Compared to harder adhesives, the soft adhesive may assist in absorbing mechanical shock that is transferred from protective sleeve 253.

In some implementations, an airgap 266 may be disposed between the first lens group 231 of lens assembly 230 and protective sleeve 253. This may allow protective sleeve 253 to absorb mechanical shock by flexing into airgap 266 upon impact, without transferring the mechanical shock into the first lens group 231. Instead, the mechanical shock is transferred to the more robust base of second lens group 232 through the adhesive 257 that may assist in absorbing the mechanical shock. Airgap 266 may exist between the top of first lens group 231 and protective sleeve 253, as illustrated. The airgap may also exist between the side of first lens group 231 and protective sleeve 253.

The adjustable lens module 240 may include a surface deformable autofocus lens that changes optical power in response to electrical signals. The surface deformable autofocus lens may include a liquid lens, for example. The illustrated tunable lens 241 includes a deformable surface 243, in the illustration of FIG. 2A.

A tunable lens may adjust its optical power in accordance with an applied signal. In some implementations, the electric signal is applied from one or more integrated electrodes of the tunable lens. A tunable lens may be an electro-optical tunable lens based on electro-wetting, may be based on electro-mechanical techniques (e.g., using piezoelectric effect to change membrane curvature), or may be based on acousto-optical techniques, for example. The tunable lens may change its focal length in response to an electrical signal (e.g. current or voltage). The curvature of one side of the tunable lens surface may change. In an implementation, the material interface curvature of two liquids changes to change the focal length of the tunable lens. In this implementation, the two liquids may have different refractive indices. In some implementation, the tunable lens is configured to adjust its optical power over a range of optical power (e.g., 0 to 5 diopters, 0 to −5 diopters, etc.). In some implementations, a tunable lens may be configured such that when no voltage is applied it still provides some amount of optical power.

A tunable lens may be designed to dynamically adjust its focal length, enabling rapid focusing without the need for mechanical movement of traditional lens elements. These tunable lenses may incorporate optical fluids, polymer membranes, or liquid crystals to alter curvature and refractive properties, providing advantages such as compactness, speed, and low power consumption in various applications.

FIG. 2B illustrates a perspective view of an example protective sleeve 283, in accordance with implementations of the disclosure. Protective sleeve 283 may be rotationally symmetric, in some implementations.

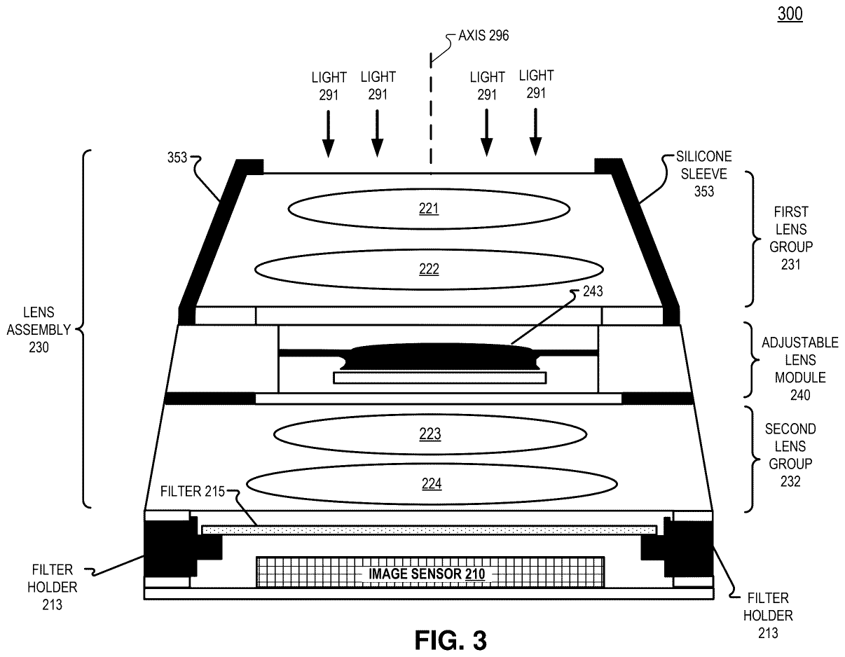

FIG. 3 illustrates a camera module 300 including a silicone protective sleeve 353, in accordance with aspects of the disclosure. Camera module 300 is similar to camera module 200 although camera module 300 includes a softer silicone sleeve compared to the protective sleeve 253 in FIG. 2A. In FIG. 3, the silicone protective sleeve 353 is coupled to the first lens group 231 to absorb mechanical shock, from drops, for example. In an implementation, silicon protective sleeve 353 is molded to the first lens group 231 and does not contact the adjustable lens module 240.

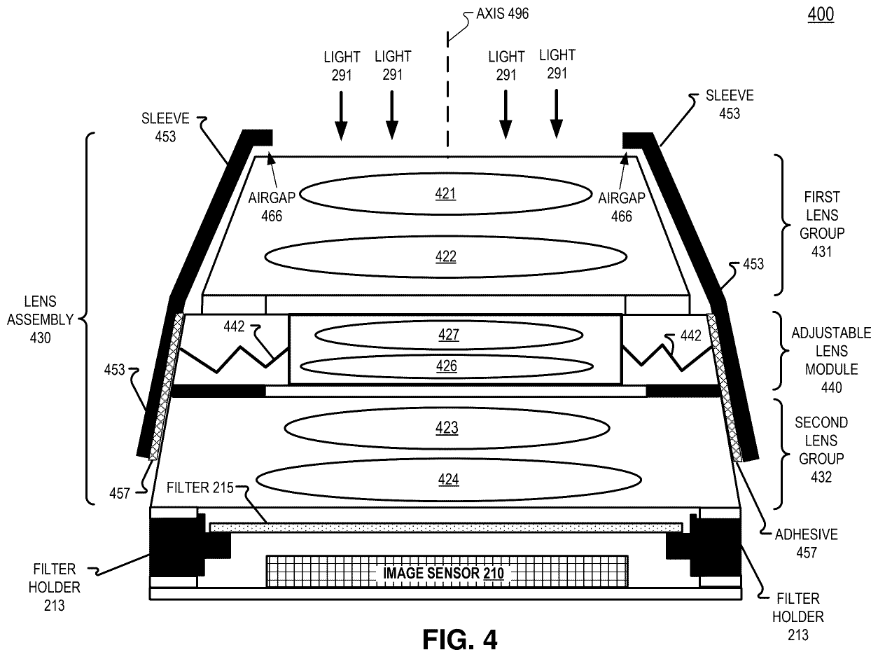

FIG. 4 illustrates a camera module 400 having a protective sleeve 453 and an adjustable lens module 440 including one or more refractive lens elements adjustable along an optical axis of the camera module, in accordance with aspects of the disclosure.

The lens assembly 430 focuses image light 291 onto the image sensor 210. Lens assembly 430 includes a first lens group 431, an adjustable lens module 440, and a second lens group 432. The first lens group 431 includes a first lens element 421 to be exposed to an external environment. The second lens group 432 shares an optical axis 296 with the first lens group 431 and the adjustable lens module 440. The second lens group 432 is disposed between the image sensor 210 and the adjustable lens module 440.

First lens group 431 may include first lens element 421 to be exposed to an external environment of a device. The first lens group 431 may include a plurality of refractive lens elements such as elements 421 and 422. The first lens element 421 (top lens element) may be glass (instead of plastic) to reduce any scratches from the first lens element 421 being exposed to the external environment. The glass of the first element may include a hard coating to avoid scratches and fingerprints, in some implementations. All or a portion of the entire first lens group 431 may be exposed to the external environment, in some aspects. The second lens group 432 may include a plurality of refractive lens elements such as elements 423 and 424. The lens elements in second lens group 432 may be plastic.

Instead of a deformable tunable lens 241 as the adjustable lens module in camera modules 200 and 300, adjustable lens module 440 traverses vertically along the optical axis 496 of the lens assembly 430 in order to adjust the optical power of the lens assembly 430. The adjustable lens module 440 may be driven by an actuator 442 such as a voice coil motor, piezoelectric actuator, and/or shape memory alloy (SMA) actuator. In some implementations, the adjustable lens module 440 in FIG. 4 includes shaft(s) and/or ball bearings to assist in facilitating adjusting the lens or lenses (e.g. lenses 426 and 427) along the optical axis 496.

In FIG. 4, the protective sleeve 453 is adhered to the second lens group 432 and the adjustable lens module 440. Protective sleeve 453 may be adhered to the second lens group 432 and the adjustable lens module 440 by a soft adhesive having a Young's modulus between 1 kPa and 100 MPa. In some implementations, adhesive 457 has a Young's modulus between 10 MPa and 100 MPa. Compared to harder adhesives, the soft adhesive may assist in absorbing any mechanical shock that is transferred from protective sleeve 453.

In camera module 200 of FIG. 2, protective sleeve 253 was not adhered to adjustable lens module 240. When adjustable lens module 240 includes a tunable lens 241, it may be advantageous to not adhere protective sleeve 253 to adjustable lens module 240 so that mechanical stress is not transferred into tunable lens 241. Hence, adhesive 257 may be placed on second lens group 232 to avoid mechanical stress being transferred into tunable lens 241 of adjustable lens module 240. However, in camera module 400 of FIG. 4, the adjustable lens module 440 may include refractive optical elements that are moved up and down optical axis 496 to adjust the focus of light 291. Adjustable lens module 440 may be made using autofocus components (including refractive lenses) that are less impacted by mechanical shock than tunable lens 241. Hence, in the case where adjustable lens module 440 includes refractive optical elements that are moved up and down optical axis 496, protective sleeve 453 may be adhered to an unmovable outside of adjustable lens module 440 without negative impacts. Of course, the unmovable outside of adjustable lens module 440 may be considered a lens holder or shield can that does not move with actuation of adjustable lens module 440, whereas the refractive optical elements in adjustable lens module 440 move along optical axis 496 during actuations of adjustable lens module 440.

In some implementations, an airgap 466 may be disposed between the first lens group 431 of lens assembly 430 and protective sleeve 453. This may allow protective sleeve 453 to absorb mechanical shock by flexing into airgap 466 without transferring the mechanical shock into the first lens group 431. Instead, the mechanical shock is transferred to the more robust base second lens group 432 through the adhesive 457 that may assist in absorbing the mechanical shock. Airgap 466 may exist between the top of first lens group 431 and protective sleeve 453, as illustrated. The airgap may also exist between the side of first lens group 431 and protective sleeve 453.

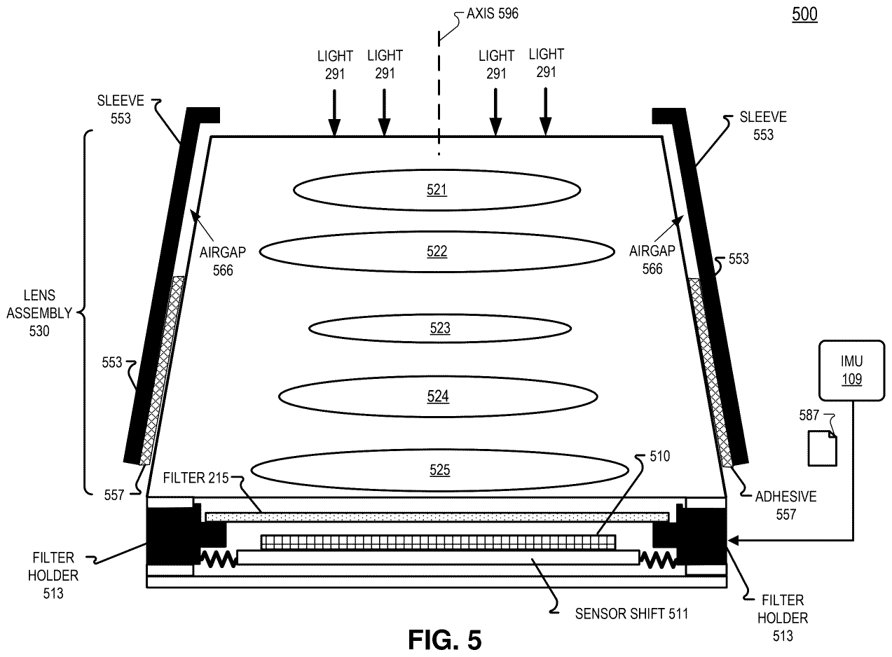

FIG. 5 illustrates a camera module 500 (for using without coverglass) that includes protective sleeve 553, in accordance with aspects of the disclosure. Camera module 500 includes OIS, but not autofocus. Existing camera modules that have OIS also have autofocus because OIS is considered an additional feature to the autofocus feature since many OIS features involve adjusting the autofocus lens to achieve OIS. Hence, it is counterintuitive to have a camera having an OIS feature without AF.

However, there are certain unique use-cases (e.g. in wearables) where having no autofocus (a fixed optical power for the optical assembly) would be useful when paired with image sensor shift OIS (instead of autofocus lens shift OIS). In these implementations, the lens assembly of the camera module 500 may have a fixed focal length that nicely focuses objects that are 0.5 meters to 5 meters away from the camera module in a wearable. In some implementations, the lens assembly may have a fixed focal length that focuses objects that are 0.5 meters to optical-infinity away from the camera module. By way of example, this camera module may be included as a forward-facing camera in a head-mounted device such as AR glasses, smartglasses, or a VR headset. The camera module may also be included in other wearable devices or other consumer electronics.

The camera module 500 in FIG. 5 includes an image sensor 510, a lens assembly 530, and a sensor shift mechanism 511. Image sensor 510 may include a CMOS image sensor. The lens assembly 530 has a fixed optical power. The illustrated lens assembly 530 includes first optical element 521, second optical element 522, third optical element 523, fourth optical element 524, and fifth optical element 525.

The lens assembly 530 is configured to focus image light 291 to an imaging plane of the image sensor 510 that is perpendicular to an optical axis 596 of the lens assembly 530. A first lens element 521 of the lens assembly 530 may be configured to be exposed to an external environment. The sensor shift mechanism 511 is configured to shift the image sensor 510 within the imaging plane for optical image stabilization (OIS) in response to a motion input signal 587. The motion input signal 587 may be received from IMU 109, for example. The motion input signal 587 may be received from a gyroscope or accelerometer. In an implementation, processing logic such as processing logic 107 may receive the motion input signal 587 and then the processing logic drives the sensor shift mechanism 511 according to an OIS algorithm.

Camera module 500 is for use without coverglass. Camera module 500 includes image sensor 510, sensor shift mechanism 511, lens assembly 530, and protective sleeve 553. Camera module 500 may include a filter holder 513 configured to provide support for filter 215 configured to filter image light 291 prior to image light 291 becoming incident on image sensor 510. Protective sleeve 553 is disposed around the lens assembly 530 to absorb a mechanical shock. Protective sleeve 553 may be metal. Protective sleeve 553 is adhered to lens assembly 530 with adhesive 557. Adhesive 557 may have the properties described with respect to adhesive 257. In FIG. 5, adhesive 557 spans from the last optical element 525 of lens assembly 530 to the third optical element 523. Adhesive 557 is not adhered above the second optical element 522, in FIG. 5.

In some implementations of camera module 500, an airgap 566 may be disposed between lens assembly 530 and protective sleeve 553. This may allow protective sleeve 553 to absorb mechanical shock by flexing into airgap 566 while transferring the mechanical shock into adhesive 557. Airgap 566 may exist between the top of optical element 521 (exposed to the external environment) and protective sleeve 553, as illustrated. The airgap may also exist between the side of lens assembly 530 and protective sleeve 553.

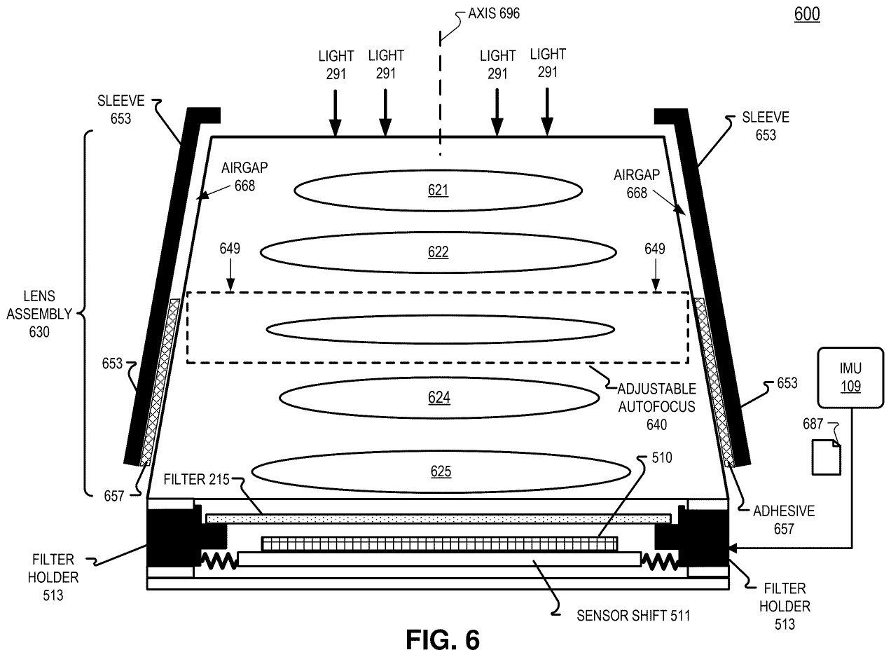

FIG. 6 illustrates a camera module 600 (for using without coverglass) that includes OIS, autofocus (AF), and protective sleeve 653, in accordance with aspects of the disclosure. Camera module 600 includes image sensor 510, a lens assembly 630, a sensor shift mechanism 511, and an adjustable autofocus lens module 640. The lens assembly 630 is configured to focus image light 291 to an imaging plane of the image sensor 510 that is perpendicular to an optical axis of the lens assembly. A first lens element 621 of the lens assembly 630 may be configured to be exposed to an external environment. The lens assembly 630 includes an adjustable autofocus (AF) lens module 640 disposed between the first lens element 621 and the image sensor 510. The adjustable AF lens module 640 may include a surface deformable autofocus lens. The adjustable AF lens module 640 may include a refractive lens adjustable along the optical axis 696 of lens assembly 630. The sensor shift mechanism 511 is configured to shift the image sensor 510 within the imaging plane for optical image stabilization (OIS) in response to a motion input signal 687.

The motion input signal 687 may be received from IMU 109, for example. The motion input signal 687 may be received from a gyroscope or accelerometer. In an implementation, processing logic such as processing logic 107 may receive the motion input signal 687 and then the processing logic drives the sensor shift mechanism 511 according to an OIS algorithm.

The illustrated lens assembly 630 includes first lens element 621, second optical element 622, adjustable autofocus lens module 640, fourth optical element 624, and fifth optical element 625. In the illustrated example, adjustable autofocus lens module 640 is disposed between second optical element 622 and fourth optical element 624.

Camera module 600 is for use without coverglass. Camera module 600 may include a filter holder 513 configured to provide support for filter 215 configured to filter image light 291 prior to image light 291 becoming incident on image sensor 510. Protective sleeve 653 is disposed around the lens assembly 630 to absorb a mechanical shock. Protective sleeve 653 may be metal. Protective sleeve 653 is adhered to a portion of lens assembly 630 with adhesive 657. Adhesive 657 may have the properties described with respect to adhesive 257. Protective sleeve 653 is adhered to a portion of the lens assembly 630 between a top 649 of the adjustable autofocus lens module 640 and the image sensor 510. In the example illustration of FIG. 6, adhesive 657 spans from the last optical element 625 of lens assembly 630 to the top 649 of adjustable autofocus lens module 640.

In an implementation, protective sleeve 663 is adhered to the portion of the lens assembly 630 between the top 649 of the adjustable autofocus lens module 640 and the image sensor 510 by a soft adhesive 657 having a Young's modulus between 1 kPa and 100 MPa, wherein the soft adhesive is configured to absorb the mechanical shock. In some implementations, adhesive 657 has a Young's modulus between 10 MPa and 100 MPa.

In some implementations of camera module 600, an airgap 668 may be disposed between lens assembly 630 and protective sleeve 653. This may allow protective sleeve 653 to absorb mechanical shock by flexing into airgap 668 while transferring the mechanical shock into adhesive 657. Airgap 668 may exist between the top of optical element 621 (exposed to the external environment) and protective sleeve 653, as illustrated. The airgap may also exist between the side of lens assembly 630 and protective sleeve 653. In an implementation, airgap 668 exists between the protective sleeve 653 and lens assembly 630 from the top 649 of the adjustable autofocus lens module 640 to the first lens element 621.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. processing logic 107) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A camera module comprising:
an image sensor; and
a lens assembly configured to focus image light to the image sensor, the lens assembly including:
a first lens group including a first lens element to be exposed to an external environment;
an adjustable lens module; and
a second lens group sharing an optical axis with the first lens group and the adjustable lens module, wherein the second lens group is disposed between the image sensor and the adjustable lens module.

2. The camera module of claim 1, wherein the adjustable lens module disposed between the first lens group and the second lens group includes a tunable lens having a deformable surface for adjusting focus of the image light to the image sensor, the camera module of claim 1 further comprising:
a protective sleeve disposed around the lens assembly, wherein the protective sleeve is adhered to the second lens group and not adhered to the first lens group nor the tunable lens so that any mechanical shock received by the protective sleeve is transferred to the second lens group and not the first lens group and not the tunable lens.

3. The camera module of claim 2, wherein the protective sleeve is a metal.

4. The camera module of claim 2, wherein the protective sleeve is adhered to the second lens group by a soft adhesive having a Young's modulus between 1 kPa and 100 MPa, wherein the soft adhesive is configured to absorb the mechanical shock.

5. The camera module of claim 2, wherein the protective sleeve is disposed around the first lens group, the second lens group, and the adjustable lens module.

6. The camera module of claim 1, wherein the adjustable lens module disposed between the first lens group and the second lens group includes a refractive lens adjustable along the optical axis of the lens assembly for adjusting focus of the image light to the image sensor, the camera module of claim 1 further comprising:
a protective sleeve disposed around the lens assembly, wherein the protective sleeve is adhered to the second lens group and the adjustable lens module.

7. The camera module of claim 6, wherein the protective sleeve is adhered to the second lens group and the adjustable lens module by a soft adhesive having a Young's modulus between 1 kPa and 100 MPa, wherein the soft adhesive is configured to absorb any mechanical shock received by the protective sleeve.

8. The camera module of claim 6, wherein the protective sleeve is disposed around the first lens group, the second lens group, and the adjustable lens module.

9. The camera module of claim 1, wherein the camera module is configured to be utilized without coverglass so that the first lens group is exposed to the external environment of a device.

10. The camera module of claim 1 further comprising:
a silicone protective sleeve coupled to the first lens group to absorb mechanical shock received by the first lens group.

11. The camera module of claim 10, wherein the silicon protective sleeve is molded to the first lens group and does not contact the adjustable lens module.

12. A camera module for use without coverglass, the camera module comprising:
an image sensor;
a sensor shift mechanism configured to shift the image sensor within an imaging plane for optical image stabilization (OIS) in response to a motion input signal; and
a lens assembly configured to focus image light to the imaging plane of the image sensor that is perpendicular to an optical axis of the lens assembly, wherein a first lens element of the lens assembly is configured to be exposed to an external environment, the lens assembly including an adjustable autofocus (AF) lens module disposed between the first lens element and the image sensor; and
a protective sleeve disposed around the lens assembly to absorb a mechanical shock, wherein the protective sleeve is adhered to a portion of the lens assembly between a top of the adjustable AF lens module and the image sensor.

13. The camera module of claim 12, wherein the protective sleeve is adhered to the portion of the lens assembly between the top of the adjustable AF lens module and the image sensor by a soft adhesive having a Young's modulus between 1 kPa and 100 MPa, wherein the soft adhesive is configured to absorb the mechanical shock.

14. The camera module of claim 13, wherein an airgap exists between the protective sleeve and the lens assembly from the top of the adjustable AF lens module to the first lens element.

15. The camera module of claim 12, wherein the adjustable AF lens module includes a surface deformable autofocus lens.

16. The camera module of claim 12, wherein the adjustable AF lens module includes a refractive lens adjustable along the optical axis of the lens assembly.

17. The camera module of claim 12, wherein the motion input signal is received from a gyroscope or accelerometer.

18. A camera module for use without coverglass, the camera module comprising:
an image sensor;
a sensor shift mechanism configured to shift the image sensor within an imaging plane for optical image stabilization (OIS) in response to a motion input signal; and
a lens assembly having fixed optical power, wherein the lens assembly is configured to focus image light to the imaging plane of the image sensor that is perpendicular to an optical axis of the lens assembly, and wherein a first lens element of the lens assembly is configured to be exposed to an external environment; and
a protective sleeve disposed around the lens assembly to absorb a mechanical shock, wherein the protective sleeve is adhered to the lens assembly.

19. The camera module of claim 18, wherein the protective sleeve include metal.

20. The camera module of claim 19, wherein an airgap exists between the metal protective sleeve and the lens assembly.
